(19) United States
(12) Patent Application Publication
(10) Pub. No.: US 2015/0342715 A1
(43) Pub. Date: Dec. 3, 2015

(54) DEVICE FOR APPLYING A FORMULATION TO SKIN

(71) Applicant: WELLMARK INTERNATIONAL, Schaumburg, IL (US)

(72) Inventors: JOHN DAVID HARTMAN, Chicago, IL (US); KIM THUY NGUYEN, Scottsdale, AZ (US)

(73) Assignee: WELLMARK INTERNATIONAL, Schaumburg, IL (US)

(21) Appl. No.: 14/821,554

(22) Filed: Aug. 7, 2015

Related U.S. Application Data
(63) Continuation of application No. 13/419,365, filed on Mar. 13, 2012.
Application No. 13/419,365 is a continuation-in-part of application No. 29/407,663, filed on Nov. 30, 2011, now Pat. No. D702563.
(60) Provisional application No. 61/483,010, filed on May 5, 2011.

(51) Int. Cl. A61D 7/00; A01K 13/00

(52) U.S. Cl. CPC A61D 7/00; A01K 13/003

(57) ABSTRACT

The application provides a device for applying a formulation to skin, the device comprising a housing, a spreading means, and an ejecting means; wherein the housing comprises a chamber for receiving a cartridge, and wherein the cartridge comprises a formulation.

This application is a continuation of U.S. patent application Ser. No. 13/419,365, filed Mar. 13, 2012, which application is a continuation-in-part of U.S. Design Patent Application No. 29/407,663, filed Nov. 30, 2011, now issued as U.S. Design Pat. No. D7025635, issued Apr. 15, 2014. The present application also claims priority of U.S. Provisional Patent Application No. 61/483,010, filed May 5, 2011. The prior applications are incorporated herein by reference in their entireties.

### BACKGROUND OF THE INVENTION

Today's spot-on applicators do not fully satisfy consumers who want to keep their hands clean, effectively apply the formulation (e.g., insecticides) to their pets' skin, and confidently apply the complete dose of formulation. There are also toxicity concerns regarding the application of insecticides, which make methods that do not require direct human contact with the insecticides more attractive.

Given these consumer needs, some advantageous features for an applicator would include 1) protection of the user's hands from inadvertent exposure to the formulation (e.g., an insecticide) during any stage of the application; 2) easy opening of a formulation container, such a disposable cartridge; 3) effective application of the formulation onto the animal's skin, despite the animal's fur; and 4) easy disposal of the formulation container. Another advantageous feature would be a way to provide feedback upon delivery of the full dosage, so the operator is confident that application is complete.

There is a need in the art for a new spot-on applicator that satisfies these consumer demands. The present invention satisfies these and other needs.

### BRIEF SUMMARY OF THE INVENTION

In certain embodiments, the present invention provides a device for applying a formulation to the skin. As such, in one embodiment, the present invention provides a device comprising:
(a) a housing, wherein the housing comprises a chamber for receiving a cartridge; wherein the cartridge comprises the formulation;
(b) a spreading means, wherein the spreading means is operably connected with the housing or cartridge; wherein during use, the spreading means moves or spreads a plurality of the skin's epidermal growths; and
(c) an ejecting means, wherein the ejecting means is operably connected with the housing.

In another embodiment, the present invention provides a device for applying a formulation to skin, the device comprising:
(a) a housing, wherein the housing comprises a chamber for receiving a cartridge; wherein the cartridge comprises the formulation;
(b) a spreading means, wherein the spreading means is operably connected with the housing or cartridge; wherein during use, the spreading means moves or spreads a plurality of the skin's epidermal growths;
(c) an ejecting means, wherein the ejecting means is operably connected with the housing;
(d) a triggering means; wherein the triggering means is operably connected with the housing or cartridge; and wherein an activation of the triggering means allows the formulation to be dispensed from the cartridge;
(e) a measuring means; wherein the measuring means is operably connected with the housing or cartridge; and wherein the measuring means allows the user to identify how much formulation has been dispensed; and
(f) a dispensing means; wherein the dispensing means is operably connected with the housing or cartridge; wherein the dispensing means dispenses the formulation from the cartridge to the skin; and wherein during use, the spreading means is proximate to the dispensing means.

In certain aspects, the present invention sets forth improvements over prior art thermoform-disposable dispensers, including hands-free cracking open of the disposable cartridge comprising the formulation, low effort dispensing of the formulation, a “fur parter” that allows the formulation (i.e., the fluid or powder) to be more accurately placed on the skin layer of the pet, and hands-free removal of empty cartridge. Advantageously, it is an ergonomically friendly device that offers increased differentiation between the dog and the cat formulas. Moreover, it creates a barrier to help prevent the dispensed formulation from getting on the operator's hands.

In certain aspects, the device provides a visual indicator showing fluid level. In certain aspects, it provides audible signals during dispensing, such as a sound indicating that a specified portion of the formulation has been dispensed (e.g., a click upon completion).

These and other embodiments will become more apparent when read with the detailed description and figures that follow.

### BRIEF DESCRIPTION OF THE DRAWINGS

FIG. 1A illustrates a top view of an embodiment of the device; FIG. 1B shows a side view of an embodiment and FIG. 1C shows a perspective view.

FIG. 2A illustrates a top view of an embodiment of the device when opened without the cartridge; FIG. 2B shows a top view of an embodiment with the cartridge in place.

FIG. 3A illustrates a top view of a second embodiment of the device; FIG. 3B shows a side view of an embodiment, and FIG. 3C shows a perspective view.

FIG. 4A illustrates a top view of an embodiment of the device when opened without the cartridge; FIG. 4B shows a top view of an embodiment with the cartridge in place.

FIGS. 5A-E illustrate a method of use for one embodiment of the device. FIG. 5A illustrates using a finger to open an embodiment's top lift door; FIG. 5B shows loading a cartridge into the device; FIG. 5C shows closing the door; FIG. 5D shows pressing the circle and apply to pet; FIG. 5E shows disposal.

FIG. 6 presents an interior view of an embodiment of the device, with a perspective view of the front, top, and right side when the device is open.

FIG. 7 presents an additional interior view of an embodiment of the device, with a view of the bottom side of a cartridge for use in the device and a partial view of the device when it is open.

FIGS. 8A-B present additional interior views of an embodiment of the device, with FIG. 8A showing the cartridge inserted into the device when it is open; and FIG. 8B showing the cartridge inserted into the device when the movable top piece is half-closed.

### DETAILED DESCRIPTION OF THE INVENTION

### I. Definitions

The terms “a,” “an,” or “the” as used herein not only includes aspects with one member, but also aspects with more than one member. For example, an embodiment including “an insecticide and a conditioner” should be understood to present aspects with at least a second insecticide, at least a second conditioner, or both.

The term “about” as used herein to modify a numerical value indicates a defined range around that value. If “X” were the value, “about X” would generally indicate a value from 0.95X to 1.05X. Any reference to “about X” specifically indicates at least the values X, 0.95X, 0.96X, 0.97X, 0.98X, 0.99X, 1.01X, 1.02X, 1.03X, 1.04X, and 1.05X. Thus, “about X” is intended to teach and provide written description support for a claim limitation of, e.g., “0.98X.” When “about” is applied to the beginning of a numerical range, it applies to both ends of the range. Thus, “from about 10° to 25°” is equivalent to “from about 10° to about 25°.” When “about” is applied to the first value of a set of values, it applies to all values in that set. Thus, “about 1°, 5°, or 10°” is equivalent to “about 1°, about 5°, or about 10°.”

In formulations comprising an “additional,” “further,” or “second” component, the second component as used herein is chemically different from the other components or first component. A “third” component is different from the other, first, and second components, and further enumerated or “additional” components are similarly different.

The term “or” as used herein should in general be construed non-exclusively. For example, an embodiment of “a formulation comprising A or B” would typically present an aspect with a formulation comprising both A and B. “Or” should, however, be construed to exclude those aspects presented that cannot be combined without contradiction.

Generally, when a range is taught, it incorporates all full or partial amount in between the endpoint (i.e., within the bounds of the range). For example, a range of 5° to 35° would also teach inter alia the specific values of 8.47° and 23°. A range of about 10° to 25° would also teach inter alia the specific values of 14.13°, 18°, and 21.1°.

### II. Embodiments

In one embodiment, the present device creates a barrier to help prevent or reduce liquid from getting on hands; optionally notifies the pet owner when application is complete (e.g., by an audible signal or visual indicator); parts hair to help the formulation gets down to the skin (e.g., by use of a fin to part the hair or fur); has a contemporary design; is ergonomically contoured for easy handling; is sturdy and secure in hand; has a better grip; and has a re-closable packaging for storage.

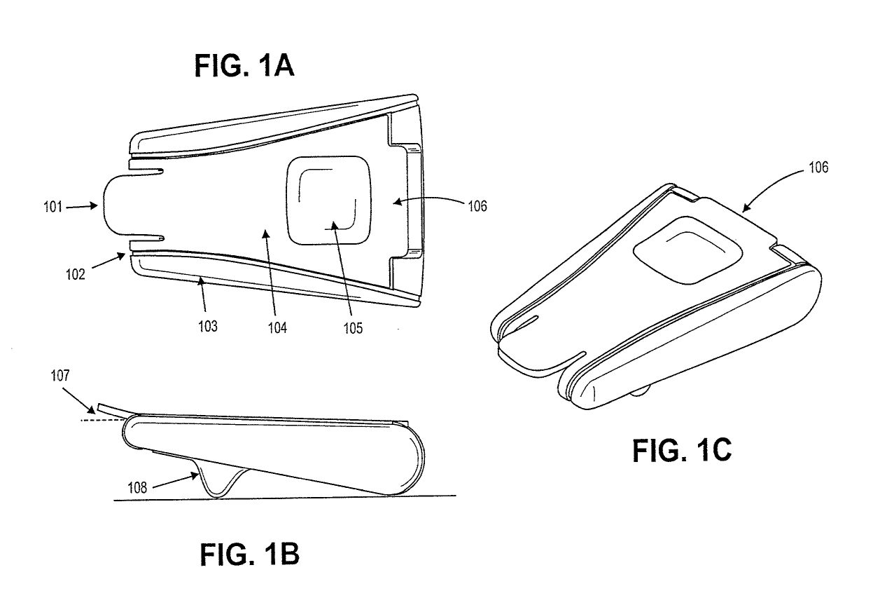

FIG. 1A illustrates a top view of an embodiment of the device. The device is well-suited for applying a formulation to the skin, such as an animal or pet (e.g., a cat or dog). In certain instances, the formulation includes an active ingredient selected from the group of an insect repellant, an insecticide, a tick repellant, a tick treatment, a mite repellent, a mite treatment, a conditioner, a moisturizer, an anti-bacterial compound, and a combination thereof. The device comprises a housing, wherein the housing comprises a chamber for receiving a cartridge; and wherein the cartridge comprises a formulation. In one embodiment, the housing is substantially composed of a polymer (e.g., a plastic), such as a thermoplastic polymer or combination of polymers. Suitable examples include, but are not limited to, polycarbonate (PC), acrylonitrile butadiene styrene (ABS) and combinations thereof (PC-ABS). Other examples include polypropylene. In certain embodiments, the device comprises no rubber. In one aspect, the housing is made of a PC-ABS type composite and the sides are made of polypropylene.

In one aspect, the device comprises a spreading means 101, wherein the spreading means is operably connected with the top of the housing 104 or cartridge; wherein during use, the spreading means moves or spreads a plurality of the skin's epidermal growths. The device has a right side and a left side of the housing, making it easy to pick up the lid 104 of the housing. FIG. 1B shows a finger grip 108 allowing for easy spreading of the formulation using 107, which is 101 in FIG. 1A. In one embodiment, the spreading means 101 is flexible, and in certain instances, moves independently from top portion 102. In certain instances, the spreading means is a tab; wherein the tab is proximate to a dispensing means for the formulation; wherein the dispensing means is operably connected with the housing or cartridge; and wherein during use, the tab spreads the plurality of epithelial growths to improve the formulation's contact with the skin. In certain instances, side portion 103 of the device is ergonomically formed. Button 105 is a triggering means.

In other embodiments, the tab has at least two projecting prongs. In other aspects, at least one prong, tine, or tooth of the spreading means comprises an angled tip. In other aspects, at least one prong, tine, or tooth has a U-shaped cross-section. In other aspects, at least one prong, tine, or tooth is cylindrical. In other aspects, the spreading means extends from the housing at a non-zero angle. In still other aspects, the non-zero angle is from 1° to 45°. In other aspects, the non-zero angle is from 5° to 35° or from 10° to 25°.

FIG. 1A and FIG. 1C shows the hinge means 106, which allows for the lifting of the lid, door or top portion of the housing.

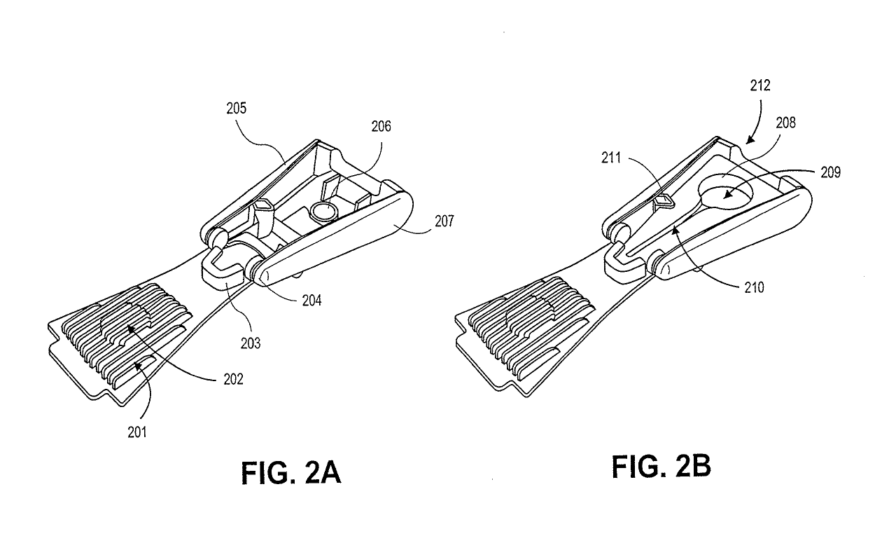

Turning now to an embodiment shown in FIG. 2A, the lid or door is lifted on the housing to show a chamber. In one aspect, the chamber is configured with a size and shape that fits a cartridge directed to a specific use. One specific use is to kill fleas and ticks on dogs. Another specific use is to kill fleas and ticks on cats. Advantageously, the use of different shapes for different formulation cartridges prevents or discourages misapplication of formulations by making it easier to distinguish cartridges with different formulations.

In one embodiment, the device's chamber is composed of a flexible, deformable material so that the chamber can be squeezed to apply pressure on the cartridge to facilitate release of the formulation from the cartridge. In certain instances, the ejecting means ejects the cartridge without the user's touching of the cartridge or formulation.

In one embodiment (e.g., FIG. 2A), the device further comprises a triggering means 201, wherein the triggering means 201 is operably connected with the housing or cartridge; and wherein an activation of the triggering means allows the formulation to be dispensed from the cartridge 210. In certain aspects, the device comprises a triggering means 201, which is a panel of ridges. In certain aspects, the triggering means comprises the opposite side of a button 202. In one instance, the triggering means is a panel 201; wherein the panel is attached to the housing, and wherein closing the panel or lid is the activation of the triggering means. In one instance, the lid is attached by a pivoting means or hinge. Feature 203 is a U-shaped raised portion, which seats cartridge properly. The side of the device 207 allows easy handling and comprises feature 204, which is this embodiment is a rounded portion on the back side of the device. The top of the housing fits with side 205 and optionally closes with a snap. FIG. 2B shows device 212 with feature 211 as an optional clip to hold the cartridge 208. Feature 209 is a reservoir and feature 210 is a channel in fluid communication therewith. Reservoir 209 holds a formulation with an active ingredient.

In certain aspects, the present invention sets forth a dispensing means that is a roller-ball tip dispenser. As the dispenser tip moves over the surface, it dispenses the formulation onto the skin or surface. If the dispenser tip stops moving, it stops dispensing the formulation. In some aspects, the invention further sets forth a spreading means that is a V-shaped trough or fin style projection that parts the hair and exposes skin for application of the medication. In some embodiments (e.g., those shown in the figures), the device includes a lip that acts to spread the fur or hair, thereby facilitating the application of the fluid to the skin. In some aspects, movement is from tail to head “against” natural hair growth direction to allow easier spreading.

In certain aspects, different medications are color-coded to prevent misapplication. In certain aspects, cartridges for different formulations are different shapes or sizes to prevent misapplication. For example, an embodiment set forth in the figures have cartridges that are different shapes to prevent a cartridge intended only for use with an animal (e.g., a dog) from being used in a dispenser designed for a second animal (e.g., a cat). This can advantageously deter negligent misapplication of medications that would be toxic to the second animal.

As mentioned, differences in cartridge design advantageously allow easy differentiation of dog and cat formulations. In one embodiment of a dog formulation, this differences include a unique or easily distinguishable packaging; a unique or easily distinguishable applicator with a rounded shape for the applicator and thermoform cartridge; and an added “DOG” embossed on applicator and thermoform.

In one example of a cat formulation, the differences include a unique or easily distinguishable packaging; a unique or easily distinguishable applicator with a squared shape for applicator and thermoform; and an added “CAT” embossed on the applicator and thermoform.

In certain instances, the applicator device and thermoforms are clearly marked and colored coded to help prevent misapplication between species and animal size. In one aspect, a dog thermoform will not work in a cat applicator and vice versa. The applicator helps create a more controlled, reliable application. It also helps prevent or reduce getting liquid on the operator's hands, and it aids in getting the applied formulation down to the skin.

In some aspects, the dispenser may be color-coded to prevent misapplication or for easy identification of the proper cartridge for use. In some aspects, the color of the movable top piece may be purple, burgundy, or red, and the remainder of the device may be black, dark gray, or light gray. Alternatively, the color of the movable top piece (or door) may be red, blue, orange, or pink, and the remainder of the device may be black, dark gray, or light gray. Alternatively, the color of the movable top piece may be green or blue (preferably, green), and the remainder of the device may be black, dark gray, or light gray.

In some aspects, the lower half of the device has a texture and color similar to the top. In other aspects, the lower half's texture or color may be different (e.g., darker). In some aspects, the texture may be different (e.g., a heavy or slightly rough texture on the bottom, and a smooth texture on the top).

In one embodiment, the device optionally comprises a measuring means 206 (e.g., a window); wherein the measuring means is operably connected with the housing or cartridge; and wherein the measuring means allows the user to identify how much formulation has been dispensed. In certain aspects, the measuring means is a transparent or translucent window 206 in the housing. In certain aspects, the device further comprises a dispensing means, wherein the dispensing means is operably connected with the housing or cartridge.

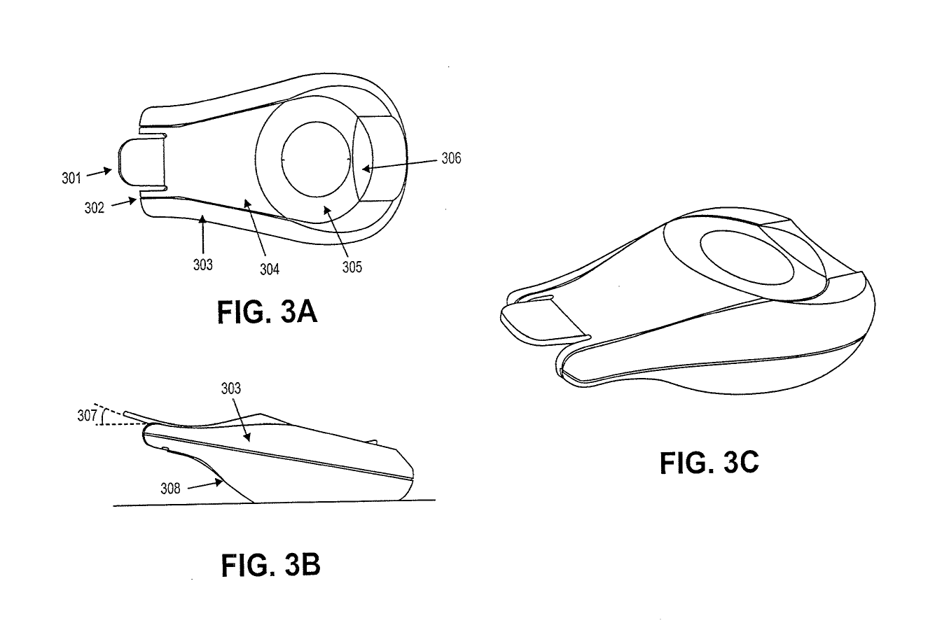

FIG. 3A illustrates a top view of one embodiment of the device. FIG. 3A has suitable features including a tab 301 for spreading a formulation, separated from the top 302 of the housing by grooves, an ergonomic side panel 303, the top of the housing 304, button 305 and hinge 306. FIG. 3B shows a side view of the device and has features including side 303, tab 307 and grip 308. FIG. 3C shows a perspective view of an embodiment. Certain of the features in FIGS. 3A-C are analogous to the features in FIGS. 1A-C.

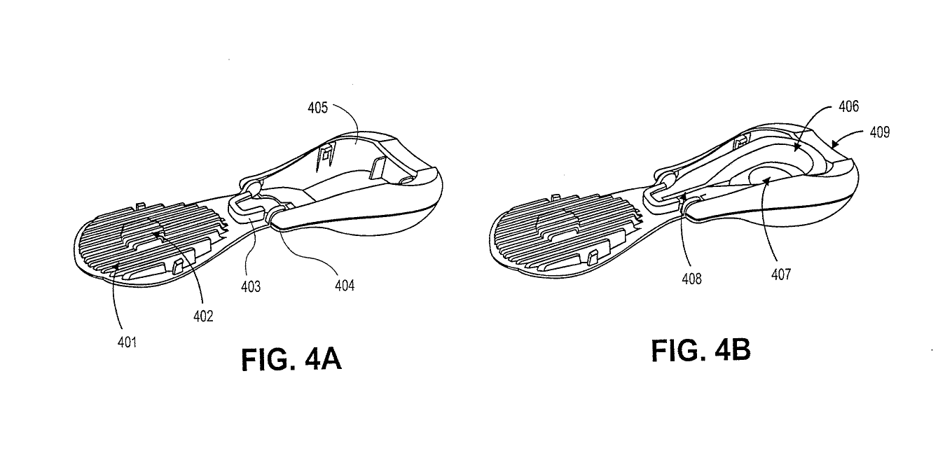

FIG. 4A illustrates a top view of the device when opened without the cartridge. FIG. 4B shows a top view with the cartridge in place. FIG. 4A has features 401, 402, 403, 404 and 405. Certain of these features are analogous to features in FIG. 2A. FIG. 4B has features 406, 407, 408, and 409. Certain of these features are analogous to features in FIG. 2B.

For example, a triggering means 401 is shown, wherein the triggering means 401 is operably connected with the housing or cartridge. FIG. 4A illustrates a top view of the device when opened without the cartridge. The cartridge sits or is disposed inside housing 405. In certain aspects, the triggering means comprises the opposite side of a button 402. In one instance, the triggering means is a panel 401; wherein the panel is attached to the housing, and wherein closing the panel or lid is the activation of the triggering means. In one instance, the lid is attached by a pivoting means or hinge. Feature 403 is a U-shaped raised portion, which seats the cartridge properly. Feature 404 is the rounded back of the device.

FIG. 4B shows a top view with the cartridge in place. Feature 407 is a reservoir and feature 408 is a channel in fluid communication with the formulation. In addition, an activation of the triggering means allows the formulation to be dispensed from the cartridge 406. Feature 409 allows for the fitting of the top of the housing or lid.

In one embodiment, the device comprises:
(a) a housing, wherein the housing comprises a chamber for receiving a cartridge; wherein the cartridge comprises the formulation;
(b) a spreading means, wherein the spreading means is operably connected with the housing or cartridge; wherein during use, the spreading means moves or spreads a plurality of the skin's epidermal growths (e.g., hair or fur);
(c) an ejecting means, wherein the ejecting means is operably connected with the housing;
(d) a triggering means; wherein the triggering means is operably connected with the housing or cartridge; and wherein an activation of the triggering means allows the formulation to be dispensed from the cartridge;
(e) a measuring means; wherein the measuring means is operably connected with the housing or cartridge; and wherein the measuring means allows the user to identify how much formulation has been dispensed; and
(f) a dispensing means; wherein the dispensing means is operably connected with the housing or cartridge; wherein the dispensing means dispenses the formulation from the cartridge to the skin; and wherein during use, the spreading means is proximate to the dispensing means.

In another embodiment, the present invention provides a kit for applying a formulation to skin, the kit comprising:
(a) a device as described herein;
(b) at least one cartridge comprising the formulation, wherein the cartridge is adapted for use in the device; and
(c) instructions for applying the formulation to skin and for ejecting the cartridge without the user's touching of the cartridge or formulation.

In another embodiment, the present invention provides a method for applying a formulation to skin, the method comprising the steps:
(a) inserting a cartridge into a device as described in the present application (e.g., any of claims 1-33), wherein the cartridge comprises the formulation;
(b) applying the formulation to the skin by means of the device; and
(c) ejecting the cartridge. In certain aspects, the method further comprises the step of activating a triggering means to allow the formulation to be dispensed from the cartridge.

In one embodiment, the device comprises five components. Component 1) is an upper shell; component 2) is a lower shell; component 3) is door; component 4) is a left-hand button; and component 5) is a right-hand button. The shells comprise the door and two buttons. In certain instances, the components are injection molded plastic. In certain instances, there are five or more unique thermoform sizes (i.e., cartridge or cartridge housing sizes) for dogs and two sizes for cats. These thermoforms fit inside the applicator without any modifications. Each thermoform is designed to fully dispense in a set number of manually applied cycles. In certain instances, the number varies by dosage size.

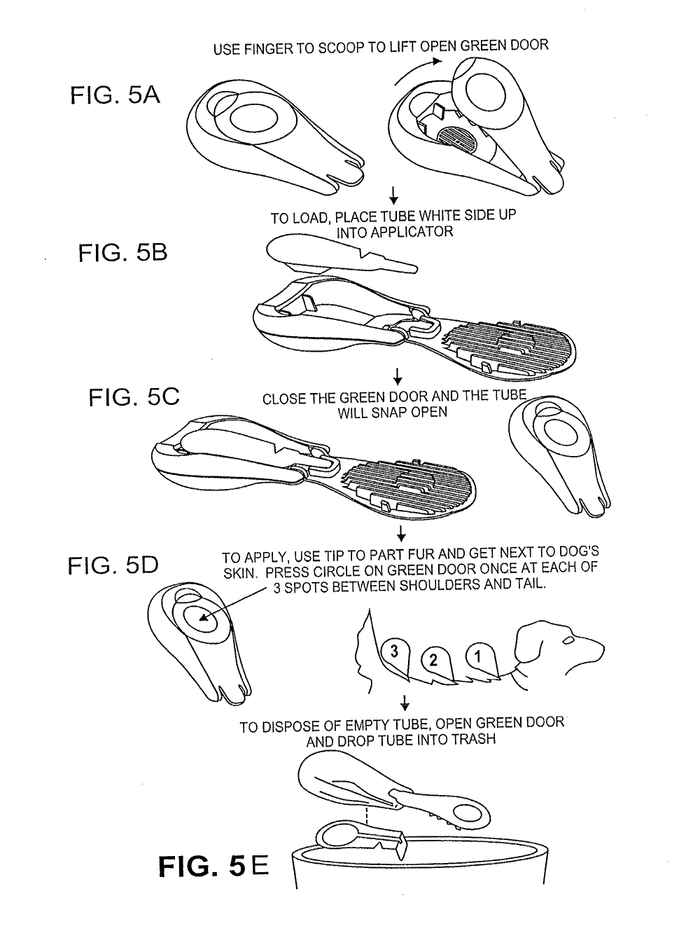

FIGS. 5A-E show the ease of use of one embodiment of the device. FIG. 5A shows opening the door; FIG. 5B shows inserting a pod or cartridge comprising a formulation; FIG. 5C shows closing the door and snapping open the cartridge's conduit for application; FIG. 5D shows applying the formulation to a pet (here, a dog); and FIG. 5E shows easy, no-mess disposal of the cartridge in the trash.

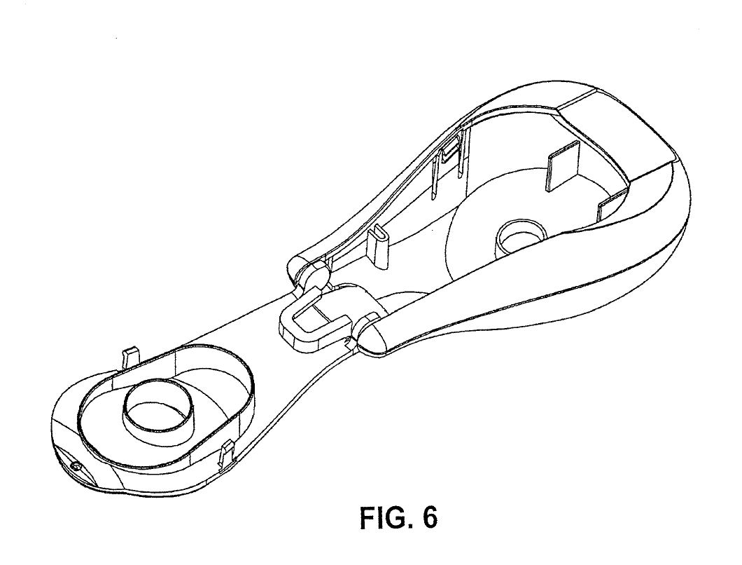

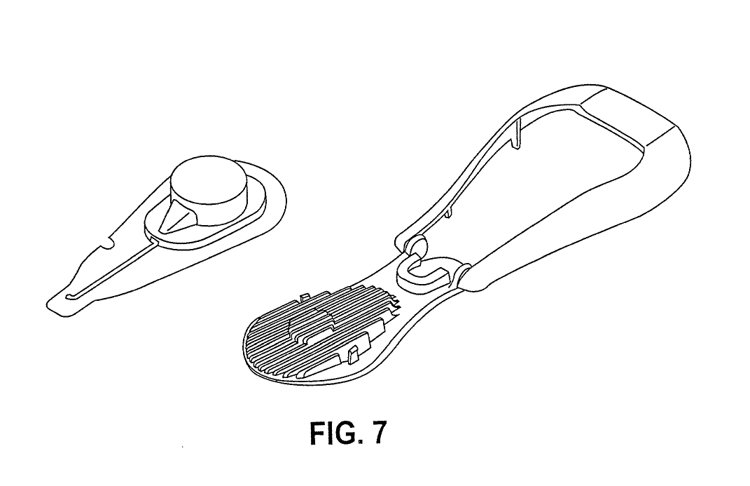

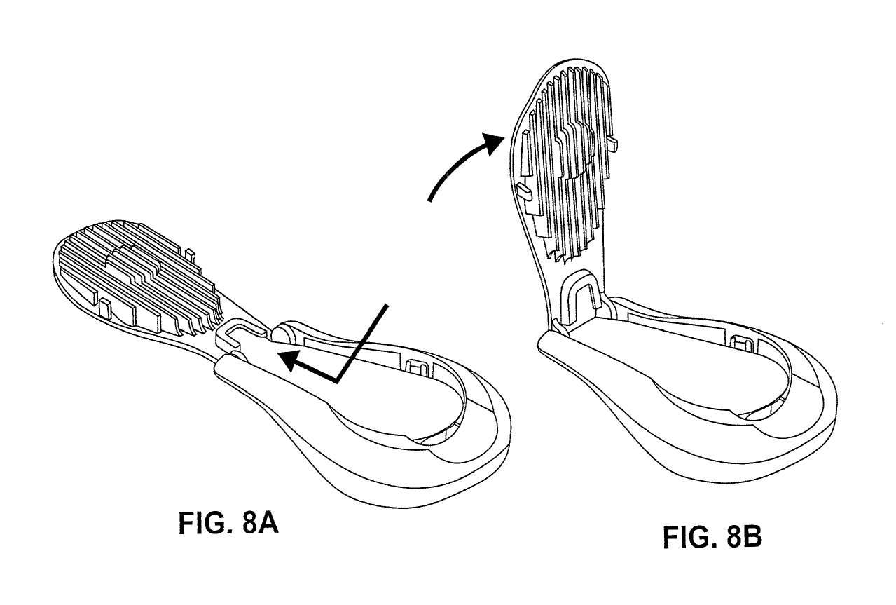

FIG. 6 presents an interior view of an embodiment of the device, with a perspective view of the front, top, and right side when the device is open and without a cartridge. In addition, FIG. 7 presents an additional interior view of an embodiment of the device, with a view of the bottom side of a cartridge for use in the device and a partial view of the device when it is open. FIGS. 8A-B present additional interior views of an embodiment of the device, with FIG. 8A showing the cartridge inserted into the device when it is open; and FIG. 8B showing the cartridge inserted into the device when the movable top piece is partially closed.

It is understood that the examples and embodiments described herein are for illustrative purposes only. Various modifications or changes in light thereof will be suggested to persons skilled in the art and are to be included within the spirit and purview of this application and scope of the appended claims. All publications, patents, and patent applications cited herein (e.g., U.S. Pat. Publ. No. 2009/0028629; U.S. Patent Publ. No. 2008/0131191; U.S. Pat. No. 4,031,239) are hereby incorporated by reference in their entirety for all purposes.

What is claimed is:

1. A device for applying a formulation to skin, the device comprising:
(a) a housing, wherein the housing comprises a chamber for receiving a cartridge; wherein the cartridge comprises the formulation;
(b) a tab which is operably connected with the housing or cartridge; wherein during use, the tab moves or spreads a plurality of the skin's epidermal growths; and the tab extends from the housing at a non-zero angle.

2. The device of claim 1, wherein the housing is substantially composed of a polymer.

3. The device of claim 1, wherein the chamber is configured with a size and shape that fits a cartridge directed to a specific use.

4. The device of claim 3, wherein the specific use is to kill fleas and ticks on dogs.

5. The device of claim 3, wherein the specific use is to kill fleas and ticks on cats.

6. The device of claim 1, wherein the chamber can be squeezed to apply pressure on the cartridge to facilitate release of the formulation from the cartridge.

7. The device of claim 1, wherein the formulation includes an active ingredient selected from the group consisting of an insect repellant, an insecticide, a tick repellant, a tick treatment, a mite repellent, a mite treatment, a conditioner, a moisturizer, an anti-bacterial compound, and a combination thereof.

8. The device of claim 1, wherein during use, the tab is proximate to a cartridge that dispenses the formulation to the skin

9. The device of claim 1, wherein the tab is operably connected with the housing.

10. The device of claim 1, wherein during use, the tab spreads the plurality of epidermal growths to improve the formulation's contact with the skin.

11. The device of claim 10, wherein the tab has at least two projecting prongs.

12. The device of claim 1, wherein the tab comprises at least one prong, tine, or tooth.

13. The device of claim 12, wherein at least one prong, tine, or tooth has a U-shaped cross-section.

14. The device of claim 12, wherein at least one prong, tine, or tooth is cylindrical.

15. The device of claim 1, wherein the non-zero angle is from 1° to 45°.

16. The device of claim 15, wherein the non-zero angle is from 5° to 35°.

17. The device of claim 16, wherein the non-zero angle is from 10° to 25°.

18. The device of claim 1, wherein after use the cartridge is ejected without a user's touching of the cartridge or formulation.

19. The device of claim 1, wherein the device further comprises:
(c) a trigger operably connected with the housing or cartridge; and wherein an activation of the trigger allows the formulation to be dispensed from the cartridge.

20. The device of claim 19, wherein the trigger is a button.

21. The device of claim 19, wherein the trigger is operably connected with the housing.

22. The device of claim 21, wherein the trigger is a panel; wherein the panel is attached to the housing, and wherein closing the panel is the activation of the trigger.

23. The device of claim 1, wherein the device further comprises:
(d) a measuring window; wherein the measuring window is operably connected with the housing or cartridge; and wherein the measuring window allows the user to identify how much formulation has been dispensed.

24. The device of claim 23, wherein the measuring window is a transparent or translucent window in the housing.

25. The device of claim 1, wherein the device further comprises:
(e) a dispenser, wherein the dispenser is operably connected with the housing or cartridge.

26. The device of claim 1, wherein the cartridge further comprises:
(1) a reservoir; wherein the reservoir comprises the formulation; and
(2) a dispenser; wherein the dispenser is operably connected with the reservoir; and wherein during use, the dispenser dispenses the formulation onto the skin.

27. The device of claim 26, wherein the dispenser is a conduit attached to the reservoir at one end.

28. The device of claim 27, wherein the conduit is sealed at one end, and wherein the seal is broken to activate the dispenser.

29. A kit for applying a formulation to skin, the kit comprising:
(a) a device of claim 1;
(b) at least one cartridge comprising the formulation, wherein the cartridge is adapted for use in the device; and
(c) instructions for applying the formulation to skin and for ejecting the cartridge without the user's touching of the cartridge or formulation.

30. A method for applying a formulation to skin, the method comprising the steps:
(a) inserting a cartridge into a device of claim 1, wherein the cartridge comprises the formulation;
(b) applying the formulation to the skin; and
(c) ejecting the cartridge.

31. The method of claim 30, the method further comprising the step of activating a trigger to allow the formulation to be dispensed from the cartridge.
